(19) United States
(12) Patent Application Publication
(10) Pub. No.: US 2026/0296375 A1
(43) Pub. Date: Oct. 1, 2026

(54) WIPER SYSTEM WITH INJECTION BY DIFFERENTIAL PRESSURE VALVE

(71) Applicant: VALEO SYSTEMES D'ESSUYAGE, La Verriere (FR)

(72) Inventors: Gerald CAILLOT, La Verriere (FR); Frederic GIRAUD, La Verriere (FR); Alexandre FILLOUX, La Verriere (FR)

(73) Assignee: VALEO SYSTEMES D'ESSUYAGE, La Verriere (FR)

(21) Appl. No.: 18/998,163

(22) PCT Filed: Jul. 26, 2023
(86) PCT No.: PCT/EP2023/070779

§ 371 Date: Jan. 24, 2025

(30) Foreign Application Priority Data
Jul. 26, 2022 (FR) 2207658

(51) Int. Cl. B60S 1/52; B60S 1/38; B60S 1/56

(52) U.S. Cl. CPC B60S 1/522; B60S 1/38; B60S 1/56

(57) ABSTRACT

The present invention relates to a motor-vehicle wiping system including a wiper blade, an arm, a first spray element able to spray cleaning fluid and a second spray element able to spray cleaning fluid. The system includes an injection assembly which is able to selectively inject cleaning fluid toward the first spray element or toward the second spray element, and which includes at least a first dual-pressure pump able to inject cleaning fluid at least a first pressure level and a second pressure level toward a first differential pressure valve able to transmit the cleaning fluid to a first distribution channel at a first pressure level and to transmit the cleaning fluid to a second distribution channel at a second pressure level.

### TECHNICAL FIELD

The present invention relates to a wiping system, notably for a motor vehicle, and in particular to a cleaning-fluid injection assembly for such a wiping system.

### BACKGROUND OF THE INVENTION

It is known practice in the field of wiping systems for glazed surfaces, notably for the windshield or rear window of a motor vehicle, to provide a plurality of longitudinal channels in a wiper blade in order to spray cleaning fluid ahead of the wiper blade onto a glazed surface of the vehicle, to enable cleaning of the window.

Wiping systems with two longitudinal channels are known, one channel being for spraying cleaning fluid ahead of the blade in a first wiping direction, and the other for spraying cleaning fluid ahead of the blade in a second wiping direction.

Other wiping systems envision spraying cleaning fluid from positions other than the wiper blade, for example by integrating fixed spray elements into the hood or into an arm that drives the rotational movement of the wiper blade.

Furthermore, motor vehicles comprise increasing numbers of sensors, most of which have an optical surface. It is necessary to clean such an optical surface in order to improve the quality of the data acquired. Wiping systems offer the capability of cleaning both the glazed surface that they wipe and, in addition, the optical surface of one or more sensors.

Thus, a plurality of spray elements are now provided in wiping systems.

Injection assemblies are therefore provided in order to convey the cleaning fluid from a reservoir to the various spray elements arranged in various elements of the wiping system and located at different locations. A distribution channel is generally provided for each set of spray elements that perform the one same given function. However, the proliferation of distribution channels, often several tens of centimeters long, makes the wiping system somewhat bulky, especially as the number of spray elements performing different or complementary functions increases. Furthermore, each distribution channel may be connected to spray elements a wiper-fluid pump specific to those spray elements, thereby increasing the bulk still further.

There is therefore a need to allow the cleaning of glazed or optical surfaces of a vehicle, without increasing the number of pumps, while structurally simplifying the injection assembly in order to reduce the cost and bulk thereof.

### SUMMARY OF THE INVENTION

The present invention relates to a wiping system comprising a wiping system comprising:
a wiper blade;
an arm able to drive the rotational movement of said wiper blade;
a reservoir of cleaning fluid;
at least one first spray element able to receive cleaning fluid and to spray said cleaning fluid;
at least one second spray element able to receive cleaning fluid and to spray said cleaning fluid;
an injection assembly which is able to selectively inject cleaning fluid from the reservoir of cleaning fluid toward said at least one first spray element or toward said at least one second spray element, said injection assembly comprising at least a first dual-pressure pump able to inject cleaning fluid from the reservoir into a first injection channel at at least a first pressure level and a second pressure level, said injection assembly further comprising a first differential pressure valve, said first valve being able to receive cleaning fluid via the first injection channel, to transmit the cleaning fluid to a first distribution channel when the cleaning fluid is received at the first pressure level and to transmit the cleaning fluid to a second distribution channel when the cleaning fluid is received at the second pressure level. The first distribution channel being configured to convey the cleaning fluid toward said at least one first spray element and said second distribution channel being configured to convey the cleaning fluid toward said at least one second spray element.

It thus becomes possible to share a pump between two distribution channels while at the same time limiting the length of these channels through the use of a differential pressure valve, while at the same time allowing selective injection into the two distribution channels. The bulk and costs associated with the wiping system are thus reduced.

According to one embodiment, the wiping system may further comprise at least one third spray element, the injection assembly comprising a second pump able to inject cleaning fluid into a third distribution channel configured to convey the cleaning fluid toward said at least one third spray element.

It is thus possible to reduce the number of pumps from three to two pumps, while allowing selective injection into the three distribution channels. Injection into the third distribution channel may thus be controlled independently of that into the first and second distribution channels.

According to other embodiments, the wiping system may further comprise at least one third spray element, the injection assembly being able to convey the cleaning fluid coming from the first dual-pressure pump into the first injection channel connected to the first differential pressure valve or into a third distribution channel configured to convey the cleaning fluid toward said at least one third spray element.

It is thus possible to share a single pump between three sets of spray elements corresponding to three respective distribution channels. The bulk and costs associated with the wiping system are thus reduced.

Depending on the embodiment, the wiping system may further comprise at least one fourth spray element, the injection assembly further comprising a fourth distribution channel configured to convey the cleaning fluid toward said at least one fourth spray element.

It is thus possible to create a complex wiping system, with a plurality of cleaning functions performed by four distribution channels, without incurring excessive bulkiness.

In addition, according to one embodiment, the wiping system may further comprise an additional pump able to inject cleaning fluid into the fourth distribution channel to convey the cleaning fluid toward said at least one fourth spray element.

It is thus possible to reduce the number of pumps, while allowing selective injection into the three distribution channels. Injection into the fourth distribution channel may thus be controlled independently of that into the first and second distribution channels.

As an alternative, according to other embodiments, the injection assembly may be able to convey the cleaning fluid coming from the second pump into the third distribution channel and into the fourth distribution channel.

Thus it becomes possible to convey along four distribution channels using only two pumps, thereby reducing the bulk and associated costs of the wiping system.

In addition, according to one embodiment, the second pump may be a two-directional pump able to selectively inject cleaning fluid into the third distribution channel and into the fourth distribution channel.

Thus, injection between the third and fourth distribution channels may be performed selectively according to the direction of rotation of the motor of the two-directional pump.

According to another embodiment, the second pump may be a dual-pressure pump able to inject cleaning fluid from the reservoir into a second injection channel at at least a third pressure level and a fourth pressure level, and the wiping system may further comprise a second differential pressure valve, said second valve being able to receive cleaning fluid via the second injection channel and to transmit the cleaning fluid to the third distribution channel when the cleaning fluid is received at the third pressure level and to transmit the cleaning fluid to the fourth distribution channel when the cleaning fluid is received at the fourth pressure level.

Thus, this alternative also allows injection that is selective between the third and fourth distribution channels.

According to another embodiment, the first pump may be a dual-pressure and two-directional pump able to selectively inject cleaning fluid into the first injection channel or into a second injection channel, and the wiping system may further comprise a second differential pressure valve, said second valve being able to receive cleaning fluid via the second injection channel and to transmit the cleaning fluid to the third distribution channel when the cleaning fluid is received at the first pressure level and to transmit the cleaning fluid to the fourth distribution channel when the cleaning fluid is received at the second pressure level.

Thus it becomes possible to selectively supply cleaning fluid to four distribution channels using only one pump, thereby reducing the bulk and associated costs of the wiping system.

Depending on the embodiment, at least one of the first and second spray elements may be able to spray cleaning fluid onto a glazed surface able to be wiped by the wiping system, and may be arranged at a fixed position on a motor-vehicle hood, in the arm or in the wiper blade.

Thus, the wiping system is able to perform at least a first function which is that of cleaning a glazed surface wiped by the wiping system.

In addition, said at least one first spray element may be arranged in the wiper blade so as to spray cleaning fluid in a first direction that is inclined with respect to a longitudinal direction of the wiper blade.

It thus becomes possible to clean the visibility zone wiped by the wiper blade. The inclined direction may be a direction normal to the longitudinal direction of the blade, or that forms a small angle, for example of less than 20°, with a normal to the longitudinal direction of the blade.

Again in addition, said at least one second spray element may be arranged in the wiper blade so as to spray cleaning fluid in a second direction that is inclined with respect to the longitudinal direction of the wiper blade, the second direction being different than the first direction.

Thus, the effectiveness associated with the cleaning of the glazed surface wiped by the wiping system is improved.

Depending on the embodiment, at least one of the spray elements may be supplied via one of the distribution channels, may be arranged in an end zone of the wiper blade and may be able to spray cleaning fluid toward an optical surface of a motor-vehicle sensor.

It thus becomes possible to perform a second cleaning function in addition to the first cleaning function.

In addition, at least another of the spray elements may be able to spray cleaning fluid toward another optical surface of another motor-vehicle sensor, said other spray element being supplied via another distribution channel.

It thus becomes possible to perform a third cleaning function in addition to the first cleaning function and to the second cleaning function.

### BRIEF DESCRIPTION OF DRAWINGS

Further features and advantages of the invention will also become apparent both from the following description and from a number of exemplary embodiments given by way of nonlimiting indication with reference to the attached schematic drawings, in which:

FIG. 1 illustrates elements of a wiping system according to one embodiment of the invention;

FIG. 2 is a view in longitudinal section of a differential pressure valve of a wiping system according to the invention;

FIG. 3 illustrates a wiping system according to the invention, mounted on a windshield of a motor vehicle;

FIG. 4a illustrates an injection assembly of a wiping system according to a first embodiment of the invention;

FIG. 4b illustrates an injection assembly of a wiping system according to a second embodiment of the invention;

FIG. 4c illustrates an injection assembly of a wiping system according to a third embodiment of the invention;

FIG. 4d illustrates an injection assembly of a wiping system according to a fourth embodiment of the invention;

FIG. 4e illustrates an injection assembly of a wiping system according to a fifth embodiment of the invention;

FIG. 4f illustrates an injection assembly of a wiping system according to a sixth embodiment of the invention; and

FIG. 4g illustrates an injection assembly of a wiping system according to a seventh embodiment of the invention.

### DETAILED DESCRIPTION OF THE INVENTION

It should first of all be noted that, although the figures set out the invention in detail for its implementation, they may, of course, be used to better define the invention if necessary. It should also be noted that, in all of the figures, elements that are similar and/or perform the same function are indicated by the same numbering.

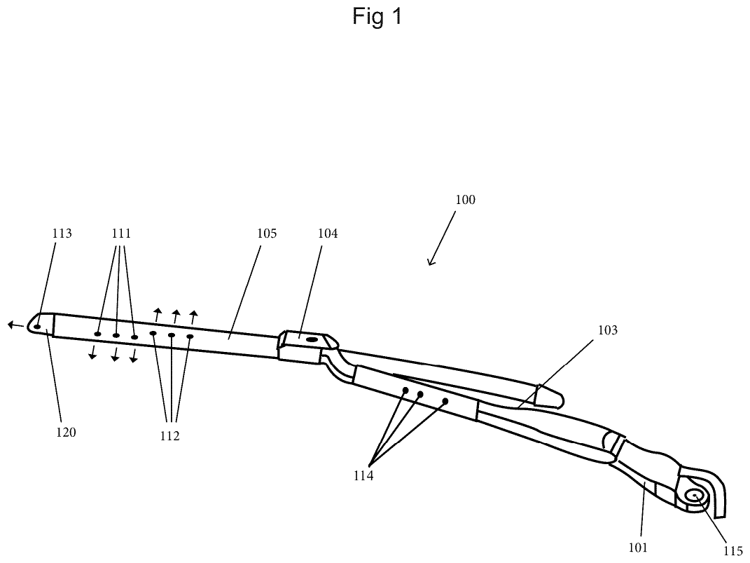

FIG. 1 illustrates elements of a motor-vehicle wiping system 100 according to one embodiment of the invention. The wiping system is able to be installed on a glazed surface of a vehicle, preferably a windshield or a rear screen window.

The wiping system comprises at least one arm 103, a wiper blade 105 attached to the arm by an attachment device 104 and configured to wipe a visibility zone of the windshield, and a drive device 101 for the arm 103, connected by a connection 115 to the motor vehicle.

The drive device 101 is configured to set the wiper blade 105 in motion via the arm 103, the wiper blade 105 being in contact with the visibility zone of the windshield. A visibility zone is a part of the windshield positioned facing a driver or a passenger of the vehicle, and through which the passenger or the driver can see the environment outside the vehicle. The movement of the arm 103 is typically a back and forth movement, preferably a circular movement. To this end, the drive device 101 may itself be moved by a motor about a pivot connection 101 making it possible to achieve the circular movement of the wiping system 100.

No restriction is imposed on the attachment device 104, which is able to allow mechanical attachment of the wiper blade 105 to the arm 103. Mechanical attachment may in particular be performed by clamping, by fitting together, or by any other means. No restriction is imposed on the degrees of freedom permitted by the mechanical connection produced by the attachment device 104.

The wiping system 100 further comprises an assembly for injecting a cleaning fluid from a reservoir, not depicted in FIG. 1, but described later, toward spray nozzles incorporated into the arm 103, into the wiper blade 105 and/or at a fixed position on a hood of the vehicle.

For example, a set of at least one spray element 111 and another set of at least one spray element 112 is arranged in the wiper blade 105 so as to spray or disperse cleaning fluid onto the visibility zone wiped by the wiping system.

The sets of spray elements 111 to 112 may both be able also to spray cleaning fluid onto the visibility zone in order to improve the effectiveness of the wiping or may be dedicated to the cleaning of a sensor other than the one targeted by the spray element(s) 113.

The spray element(s) 111 may be able to spray cleaning fluid onto the visibility zone wiped by the blade 105 of the wiping system, so as to improve the cleaning of such a surface. The spray element(s) 112 may be able also to spray cleaning fluid onto the visibility zone, in addition to the first spray elements, so as to improve the effectiveness of the wiping, or may be dedicated to the cleaning of a sensor other than the one targeted by the third spray element(s).

In that which follows, it is considered, solely by way of illustration, that the spray elements 111 and 112 spray toward the one same visibility zone wiped by the blade 105.

To that end, it is notably considered that the spray elements 111 and 112 spray in two distinct directions, both inclined with respect to a longitudinal direction of the wiper blade 105, so as to spray in different directions of wiping of the wiping system 100.

For example, the spray element(s) 111 may be able to spray cleaning fluid toward the glazed surface in an upward direction of wiping, and the spray element(s) 112 may be able to spray cleaning fluid toward the glazed surface in a downward direction of wiping. An upward direction may correspond to a wiping movement from the hood toward the roof of the vehicle, when the glazed surface is a windshield.

This then ensures that the cleaning fluid is always sprayed ahead of the wiper blade 105. It thus becomes possible to improve the driver's visibility through the visibility zone and to make the wiping by the wiper blade 105 more effective. Such a wiper blade 105 with spraying in one channel in one direction and in another channel in another direction is referred to as a “dual-ramp” blade.

As an alternative, just one or more spray element(s) 111 are provided in the wiper blade 105, the wiper blade not comprising the spray elements 112. In that case, the wiper blade 105 is said to be a “single-ramp” blade.

Furthermore, the wiper blade may comprise at least one spray element 113 able to spray or to disperse cleaning fluid and arranged in a longitudinal end zone of the wiper blade 105. What is meant by a longitudinal end zone is a zone all of the positions of which are closer to the longitudinal end of the wiper blade than to a central position of the wiper blade. The central position may notably correspond to the position of the attachment device 104 providing attachment between the wiper blade 103 and the arm 105 of the wiping system. Preferably, the longitudinal end zone includes all of the positions which are twice as close, or even three times as close, to the longitudinal end as to the central position of the wiper blade.

The spray element(s) 113 may be able to spray cleaning fluid:
toward a sensor of the vehicle, such as a lidar, situated outside of the visibility zone of the windshield;
onto the visibility zone wiped by the wiping system; and/or
toward another sensor of the vehicle, for example likewise situated outside of the visibility zone of the windshield.

If a plurality of functions are performed by the spray elements 113, for example a function of cleaning a first sensor and a function of cleaning a second sensor, the spray elements 113 performing the different functions may be supplied via different distribution channels or via the one same distribution channel.

No restriction is imposed on the structure of such spray elements, which are well known to those skilled in the art.

According to embodiments of the invention, spray elements are all arranged in the wiper blade 105.

One or more spray elements 114 may be integrated into the arm 103, the spray elements 114 being able to disperse cleaning fluid. The spray elements may notably be alternatives to the spray elements 111 and 112, in which case the wiping system 100 comprises either spray elements 114 or spray elements 111 and 112.

Each spray element or set of spray elements 111, 112, 113 or 114 described hereinabove may be in fluidic communication with a distribution channel. A distribution channel may thus be dedicated to a given cleaning function, whether this be the cleaning of a sensor or the cleaning of a glazed surface wiped by the wiping system 100.

Thus, up to four distribution channels may be required, for example in embodiments based on a dual-ramp cleaning system with spray nozzles 111 and 112, and able to clean to sensors via several spray nozzles 113. As an alternative according to the invention, the wiping system 100 may comprise two or three distribution channels.

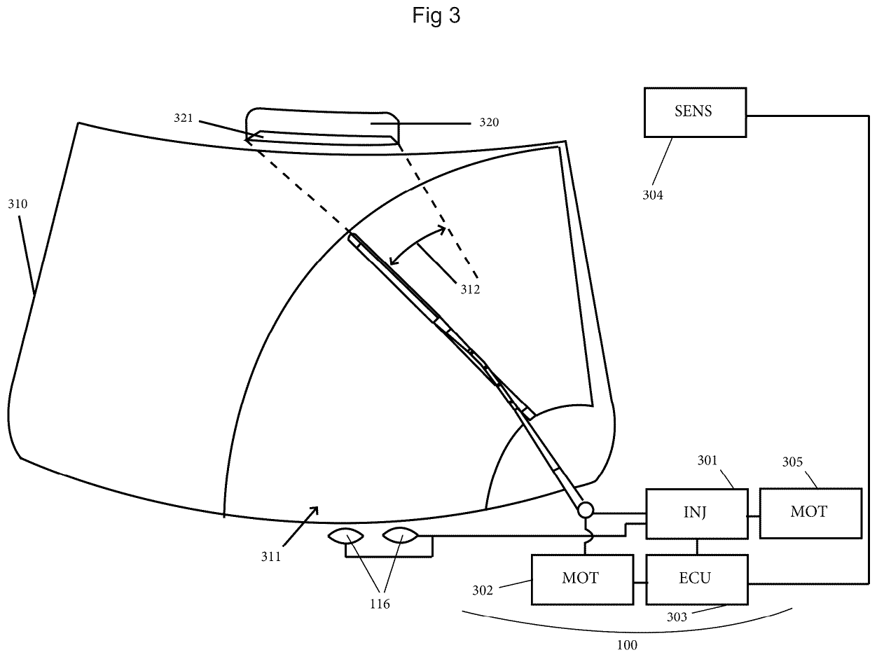

As will be described later on with reference to FIG. 3, one or more spray element(s) 116 may be arranged fixedly on a hood of the vehicle in place of the spray elements 111, 112 and 114 described hereinabove.

In order to limit the number of pumps and the length of the distribution channels, and therefore the bulk and the costs associated with the wiping system, the present invention envisions the use of a differential pressure valve in a wiping system.

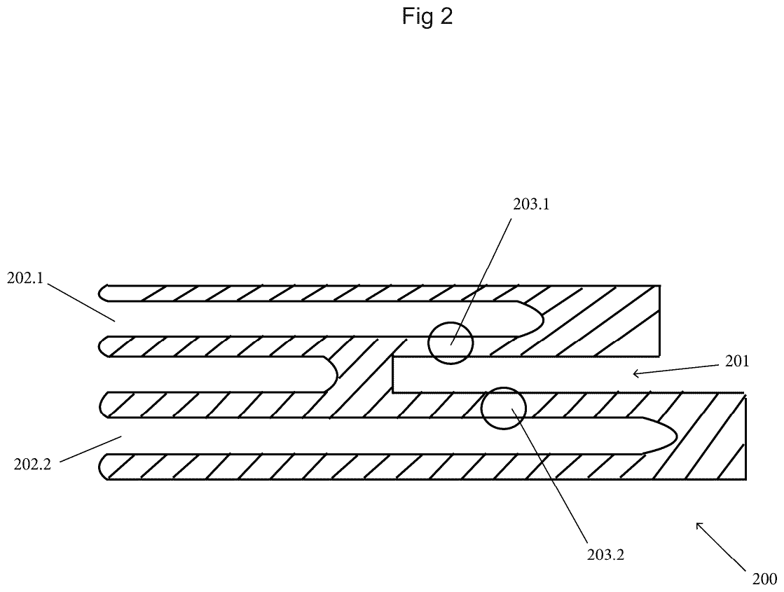

FIG. 2 illustrates a view in longitudinal section of a differential pressure valve 200 of a wiping system according to one embodiment of the invention.

The differential pressure valve 200, also referred to as a “Y-valve”, comprises an inlet 201, a first outlet 202.1 and 202.2. When a fluid, such as a cleaning fluid for cleaning a glazed surface, is received via the inlet 201 of the valve 200, the valve 200 is able to convey the fluid toward the first outlet 202.1 or toward the second outlet 202.2 according to the pressure level of the fluid received at the inlet.

To this end, a first transition channel 203.1 may be able to allow the fluid to pass from the inlet 201 to the first outlet 202.1 when the fluid received is at a first pressure level. A second transition channel 203.2 may be able to allow the fluid to pass from the inlet 201 to the second outlet 202.2.

The valve 200 may notably comprises a piston, not depicted in FIG. 2, arranged in the inlet 200 and the position of which varies according to the pressure level so as to allow the fluid to pass through the first transition channel 203.1 or through the second transmission channel 203.2.

The expressions “first pressure level” and “second pressure level” may refer to discrete pressure values, but preferably refer to an interval of pressure values centered around a central pressure value. The pressure intervals corresponding respectively to the first pressure level and to the second pressure level are preferably non-contiguous.

Such a differential pressure valve 200 is thus able to receive, via its inlet 201, a channel for injecting cleaning fluid from a dual-pressure pump able to inject fluid at least at the first pressure level and at the second pressure level, selectively.

FIG. 3 shows a wiping system 100 mounted on a windshield 310 of a motor vehicle according to one embodiment of the invention.

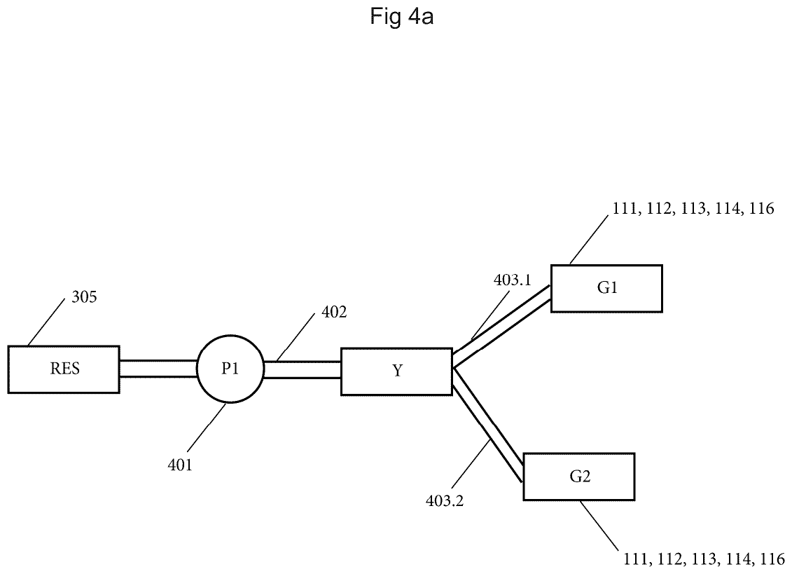

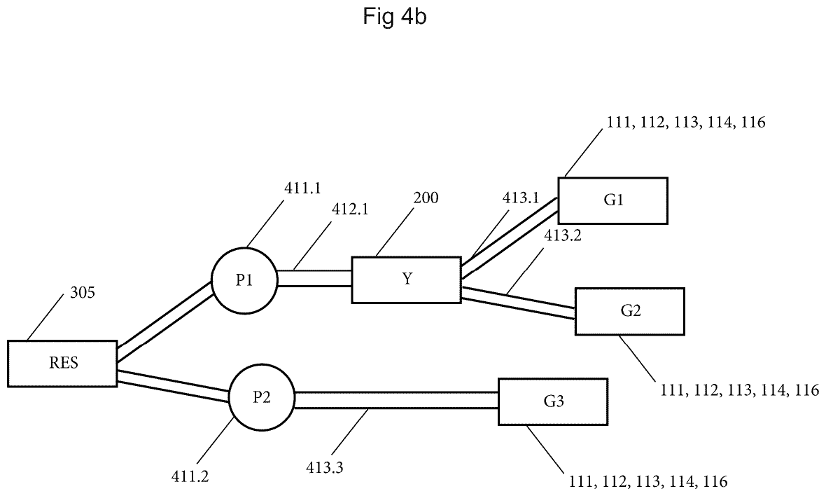

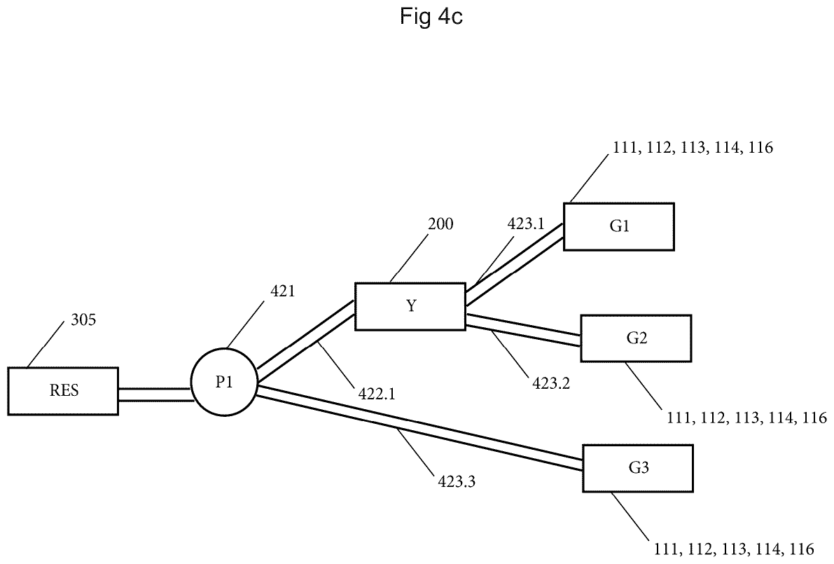

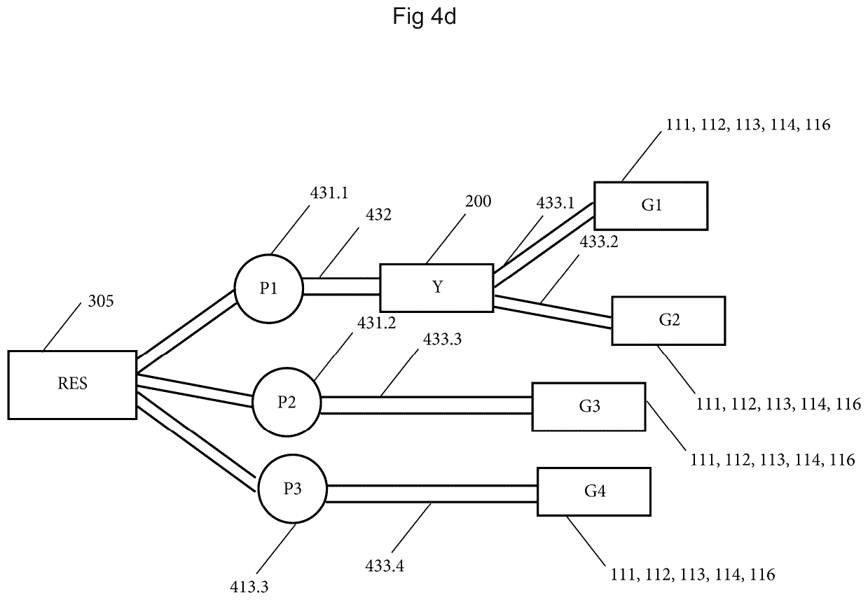

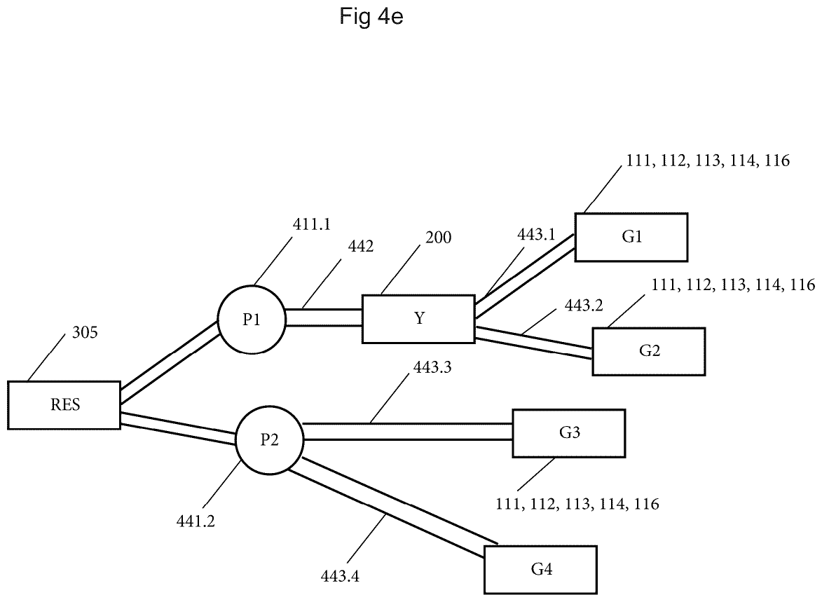

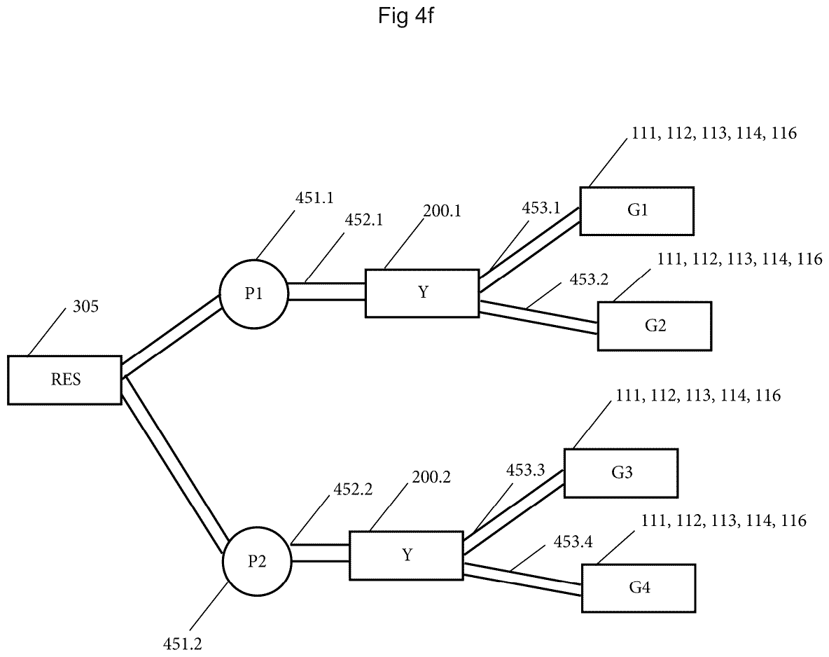

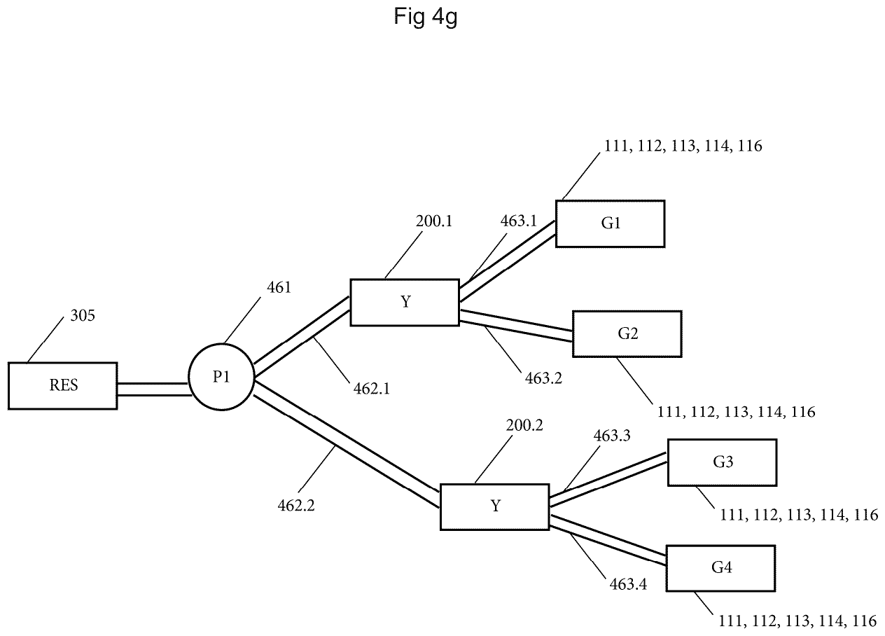

As illustrated, the wiping system 100 further comprises an injection assembly 301 able to selectively inject cleaning fluid into the at least two distribution channels of the wiping system 100. The injection system 301 according to the invention comprises at least one differential pressure valve 200 and one dual-pressure pump. Embodiments of such an injection system 301 will be described later with reference to FIG. 4a to FIG. 4g.

The wiping system 100 may further comprise a motor 302 for driving the arm 105, and a control unit 303.

No restriction is imposed on the motor 302, which includes any reversible motor making it possible to rotate the movable part of the wiping system 100 in one direction then in another.

As will be understood more clearly on reading the description of the following figures, the injection assembly 301 may comprise elements mounted on the arm 105 and/or in the wiper blade 105, and/or on a hood of the vehicle.

No restriction is imposed on the control unit 303, which may be a dedicated control unit of the wiping system 100, or which may be a central control unit of the vehicle, also called the ECU, which stands for “Electronic Control Unit”, or the “Body Controller”.

The ECU 303 may be able to receive position data concerning the movable part of the wiping system, notably including the arm 103 and the wiper blade 105. Such position data are preferably received regularly, at a frequency greater than around ten hertz, when the wiping system 100 is activated.

The position data may be received from the motor 302, or alternatively from a detection device 304 capable of detecting the position of the movable part of the wiping system. No restriction is imposed on the detection device 304, which may be a camera for example.

The position data may include:
an angular position of the arm 103 and/or the wiper blade 105 within a predetermined range of wiping angles 311 corresponding to the visibility zone of the windshield; and/or
a speed of rotation of the arm 103 and/or the wiper blade 105.

Furthermore, as depicted in FIG. 3, the system 100 may comprise one or more spray element(s) 116 able to spray cleaning fluid onto the windshield 310 wiped by the wiping system 100, and arranged in a fixed position on a hood of the motor vehicle.

The injection assembly 301 is able to inject, selectively, cleaning fluid into several of the distribution channels in fluidic communication with the spray elements 111, 112, 113, 114 or 116 that the wiping system 100 comprises. It will be recalled that the wiping system may comprise just some of the spray elements described hereinabove, it notably being possible for the spray elements 111, 112, 114 and 116 to be used as alternatives for one another. Certain examples of wiping systems according to the invention may comprise:
one or more spray element(s) 116 on the hood and at least one spray element 113 able to spray cleaning fluid onto an optical surface of a sensor arranged outside of the visibility zone of the windshield with, optionally, another spray element 113 able to spray onto an optical surface of another sensor;
one or more spray element(s) 114 in the arm 105 and at least one spray element 113 able to spray cleaning fluid onto an optical surface of a sensor arranged outside of the visibility zone of the windshield with, optionally, another spray element 113 able to spray onto an optical surface of another sensor;
one or more spray element(s) 111 in the wiper blade 103 and at least one spray element 113 able to spray cleaning fluid onto an optical surface of a sensor arranged outside of the visibility zone of the windshield with, optionally, another spray element 113 able to spray onto an optical surface of another sensor;
one or more spray element(s) 111 and one or more spray element(s) 112 in the wiper blade 103 and at least one spray element 113 able to spray cleaning fluid onto an optical surface of a sensor arranged outside of the visibility zone of the windshield with, optionally, another spray element 113 able to spray onto an optical surface of another sensor; or
one or more spray element(s) 111 and one or more spray element(s) 112 in the wiper blade 103.

The injection assembly 301 is able to selectively inject cleaning fluid into the plurality of distribution channels that are respectively connected to the spray elements of the wiping system 100. At a given moment, the injection assembly may be able to spray cleaning fluid into one or more distribution channel(s) (or over a range of time between receipts of consecutive position data).

The selection of distribution channels into which cleaning fluid is injected may be performed on the basis of control signals transmitted by the control unit 303. As an alternative, a plurality of control units 303 may be provided, notably when distinct cleaning functions are performed via the different longitudinal channels. In that which follows, the example of a single control unit 303 is considered solely by way of illustration.

The control unit 303 is able to determine such control signals on the basis of the position data received either from the motor 302 or from the detection device 304. In particular, the control unit 303 may determine, on the basis of the position data, whether the wiper blade 105 is wiping in an upward or downward direction. In an example of a dual-ramp wiping system with spray elements 111, 112 and 113, which is considered here by way of illustration, it may emit control signals destined for the injection unit 301:
to inject cleaning fluid toward spray elements 111 when the blade 105 is in a downward wiping direction;
to inject cleaning fluid toward spray elements 112 when the blade 105 is in a downward wiping direction.

As the change in wiping direction approaches, when the speed of the blade 105 becomes low in absolute value before becoming zero, the injection of cleaning fluid toward the spray elements 111 and 112 may be suspended.

In addition, in this example, the control unit 303 may be configured to control the injection of cleaning fluid by the injection assembly 301, toward the spray element 113, when the arm 103 and/or the wiper blade 105 is located in an angular sector 312 strictly included in the angular range 311 described above. The angular sector may notably be less than 30°, for example less than 20°.

The angular sector 312 may be defined such that the wiping system sprays cleaning fluid via the third spray element 113 toward an optical surface 321 of a sensor 320 of the vehicle. No restriction is imposed on the sensor 320 in question, which may be a lidar for example, nor on the position of this sensor 320. By way of example, in FIG. 3, a lidar-type sensor is shown, in a position centered above the windshield 310 of the vehicle.

Thus, the angular sector 312 makes it possible to define a set of positions in which the third spray element 113 is facing a part of the optical surface 321 of the sensor 320, or is approaching the optical surface.

The angular sector 312 may advantageously depend on:
geometric characteristics of the wiping system, in particular of the arm 103 and of the wiper blade 105;
geometric characteristics of the optical surface 321;
the respective positioning between the wiping system 100 and the optical surface 321;
the part of the optical surface 321 to be cleaned. To be specific, the angular sector 312 may be defined to spray cleaning fluid onto only a part of the optical surface 321, for example onto a central part and/or
the wiping speed of the wiping system 100. The control signals may thus trigger injection of the product before the third spray element 113 is facing the optical surface 321.

The control unit 303 may control the injection assembly 301 so as to inject cleaning fluid toward the spray element 113:
when the arm and/or the wiper blade 105 is in the angular sector 312, in the upward wiping direction;
when the arm and/or the wiper blade 105 is in the angular sector 312, in the downward wiping direction; and/or
when the arm and/or the wiper blade 105 is in the angular sector 312, regardless of the wiping direction.

It thus becomes possible to allow cleaning of an optical surface of a sensor situated outside of the visibility zone of the windshield on which a wiping system is mounted, without having to add a cleaning device especially for the sensor, while optimizing the consumption of cleaning fluid.

The wiping system in FIG. 3 comprises a single wiper blade/arm assembly.

However, it may comprise two such assemblies, one situated on the driver side and the other on the passenger side. The two assemblies may be controlled by the control unit 303 in the manner described above. Alternatively, only one of these assemblies comprises a third spray element 113 and a third longitudinal channel 230. It may for example be the passenger-side blade/arm assembly, or, alternatively, the driver-side blade/arm assembly.

The wiping system 100 further comprises a reservoir 305 of cleaning fluid. The injection assembly 301 is thus able to convey the cleaning fluid from the reservoir 305 toward the spray elements 111, 112, 113, 114 and 116.

The embodiments described below differ in terms of the cleaning fluid injection assembly 301.

FIG. 4a presents a first fluid injection assembly 301 of a wiping system according to a first embodiment of the invention.

In the first embodiment, the injection assembly 301 comprises a dual-pressure pump 401 able to inject cleaning fluid from the reservoir 305 at a first pressure level and at a second pressure level into an injection channel 402.

The injection assembly 301 further comprises a differential pressure valve 200 able to receive cleaning fluid via the injection channel 402, and to transmit it into a first distribution channel 403.1 or into a second distribution channel 403.2 according to the pressure of the cleaning fluid.

The first distribution channel 403.1 is able to convey cleaning fluid toward one or more first spray element(s) 111, 112, 113, 114 or 116, and the second distribution channel 403.2 is able to convey cleaning fluid toward one or more second spray element(s) 111, 112, 113, 114 or 116.

The pump 401 may notably be controlled by the control unit 303 via control signals so as to vary the cleaning-fluid injection pressure and thus selectively inject cleaning fluid into the first distribution channel or into the second distribution channel.

Thus, in the first embodiment, the wiping system comprises two distribution channels leading to distinct spray elements and may advantageously use a differential pressure valve 200 enabling the use of a single pump and making it possible to shorten the length of the distribution channels 403.1 and 403.2. For example, the first spray element(s) may be spray elements 111 for spraying onto the windshield 310 in an upward direction of wiping and the second spray element(s) may be spray elements 112 for spraying onto the windshield 310 in a downward direction of wiping.

The injection channel 402 may be connected to the arm 103, or even integrated under a protection of the arm 103, so as not to hinder wiping by the movable part of the wiping system 100. The same goes for the injection channels presented in the embodiments of the subsequent figures, when the spray elements are in the wiper blade 105.

FIG. 4b presents a second fluid injection assembly 301 of a wiping system according to a second embodiment of the invention.

In the second embodiment, the injection assembly 301 comprises a first dual-pressure pump 411.1 able to inject cleaning fluid from the reservoir 305 at a first pressure level and at a second pressure level into an injection channel 412.1.

The injection assembly 301 further comprises a differential pressure valve 200 able to receive cleaning fluid via the injection channel 412.1, and to transmit it into a first distribution channel 413.1 or into a second distribution channel 413.2 according to the pressure of the cleaning fluid.

The first distribution channel 413.1 is able to convey the cleaning fluid toward one or more first spray element(s) 111, 112, 113, 114 or 116, and the second distribution channel 413.2 is able to convey the cleaning fluid toward one or more second spray element(s) 111, 112, 113, 114 or 116.

The injection assembly further comprises a second pump 411.2 able to inject cleaning fluid from the reservoir 305 into a third distribution channel 413.3 able to convey cleaning fluid toward one or more third spray element(s) 111, 112, 113, 114 or 116.

Thus, in the second embodiment, the wiping system comprises three distribution channels leading to distinct spray elements and may advantageously use a differential pressure valve 200 enabling the use of two pumps in place of three and making it possible to shorten the length of the distribution channels 413.1 and 413.2, The pumps 411.1 and 411.2 may be controlled by the control unit 303 or by a plurality of control units 303.

FIG. 4c presents a third fluid injection assembly 301 of a wiping system according to a third embodiment of the invention.

In the third embodiment, the injection assembly 301 comprises a dual-pressure and two-directional pump 421 able to inject cleaning fluid from the reservoir 305 at a first pressure level and at a second pressure level into a first injection channel 422.1 or into a second injection channel 423.3 according to the direction of rotation of the motor of the pump 421. Alternatively, the pump 421 may be replaced by a dual-pressure, but not two-directional, pump, connected by a single channel to a solenoid valve able to be controlled in such a way as to connect the single channel to the first injection channel 422.1 or to the second injection channel 423.3. The pump 421, and optionally the solenoid valve, may both be controlled by the control unit 303, or by a plurality of control units 303.

The injection assembly 301 further comprises a differential pressure valve 200 able to receive cleaning fluid via the first injection channel 422.1, and to transmit it into a first distribution channel 423.1 or into a second distribution channel 423.2 according to the pressure of the cleaning fluid.

The first distribution channel 423.1 is able to convey the cleaning fluid toward one or more first spray element(s) 111, 112, 113, 114 or 116, and the second distribution channel 423.2 is able to convey the cleaning fluid toward one or more second spray element(s) 111, 112, 113, 114 or 116.

The second injection channel 423.3 is able to convey cleaning fluid toward one or more third spray element(s) 111, 112, 113, 114 or 116. The second injection channel 423.3 thus constitutes a third distribution channel.

Thus, in the third embodiment, the wiping system 100 comprises three distribution channels leading to distinct spray elements and may advantageously use a differential pressure valve 200 enabling the use of a single pump in place of three and making it possible to shorten the length of the distribution channels 423.1 and 423.2.

FIG. 4d presents a fourth fluid injection assembly 301 of a wiping system according to a fourth embodiment of the invention.

In the fourth embodiment, the injection assembly 301 comprises a first dual-pressure pump 431.1 able to inject cleaning fluid from the reservoir 305 at a first pressure level and at a second pressure level into an injection channel 432.

The injection assembly 301 further comprises a differential pressure valve 200 able to receive cleaning fluid via the injection channel 432, and to transmit it into a first distribution channel 433.1 or into a second distribution channel 433.2 according to the pressure of the cleaning fluid.

The first distribution channel 433.1 is able to convey the cleaning fluid toward one or more first spray element(s) 111, 112, 113, 114 or 116, and the second distribution channel 433.2 is able to convey the cleaning fluid toward one or more second spray element(s) 111, 112, 113, 114 or 116.

The injection assembly 301 further comprises a second pump 431.2 able to inject cleaning fluid from the reservoir 305 into a third distribution channel 433.3 able to convey cleaning fluid toward one or more third spray element(s) 111, 112, 113, 114 or 116.

The injection assembly 301 further comprises a third pump 431.3 able to inject cleaning fluid from the reservoir 305 into a fourth distribution channel 433.4 able to convey cleaning fluid toward one or more fourth spray element(s) 111, 112, 113, 114 or 116.

The pumps 431.1, 431.2 and 431.3 may be controlled by the control unit 303 or by a plurality of control units 303.

Thus, in the fourth embodiment, the wiping system comprises four distribution channels leading to distinct sets of spray elements and may advantageously use a differential pressure valve 200 enabling the use of three pumps in place of four and making it possible to shorten the length of the distribution channels 433.1 and 433.2.

FIG. 4e presents a fifth fluid injection assembly 301 of a wiping system according to a fifth embodiment of the invention.

In the fifth embodiment, the injection assembly 301 comprises a first dual-pressure pump 441.1 able to inject cleaning fluid from the reservoir 305 at a first pressure level and at a second pressure level into an injection channel 442.

The injection assembly 301 further comprises a differential pressure valve 200 able to receive cleaning fluid via the injection channel 442, and to transmit it into a first distribution channel 443.1 or into a second distribution channel 443.2 according to the pressure of the cleaning fluid.

The first distribution channel 443.1 is able to convey the cleaning fluid toward one or more first spray element(s) 111, 112, 113, 114 or 116, and the second distribution channel 443.2 is able to convey the cleaning fluid toward one or more second spray element(s) 111, 112, 113, 114 or 116.

The injection assembly 301 further comprises a second pump 441.2 able to inject cleaning fluid from the reservoir 305 into a third distribution channel 443.3 or into a fourth distribution channel 443.4. To this end, the second pump 441.2 may be a two-directional pump or a combination of a pump and a solenoid valve, as described hereinabove.

The third distribution channel 443.3 is able to convey the cleaning fluid toward one or more third spray element(s) 111, 112, 113, 114 or 116, and the fourth distribution channel 443.4 is able to convey the cleaning fluid toward one or more fourth spray element(s) 111, 112, 113, 114 or 116.

The pumps 441.1 and 441.2, and optionally the solenoid valve, may be controlled by the control unit 303 or by a plurality of control units 303.

As an alternative, the first pump 441.1 may be a two-directional and dual-pressure pump and able to convey cleaning fluid either into the injection channel 442 connected to the differential valve or into the third distribution channel 443.3, according to the direction of rotation of the motor of the first pump 441.1. In that case, the second pump 441.2 is a simple pump with a single outlet connected to the fourth distribution channel 443.4.

Thus, in the fifth embodiment, the wiping system 100 comprises four distribution channels leading to distinct sets of spray elements and may advantageously use a differential pressure valve 200 enabling the use of two pumps in place of four and making it possible to shorten the length of the distribution channels 443.1 and 443.2.

FIG. 4f presents a sixth fluid injection assembly 301 of a wiping system according to a sixth embodiment of the invention.

In the sixth embodiment, the injection assembly 301 comprises a first dual-pressure pump 451.1 able to inject cleaning fluid from the reservoir 305 at a first pressure level and at a second pressure level into a first injection channel 452.1, and a second dual-pressure pump 451.1 able to inject cleaning fluid from the reservoir 305 into a second injection channel 452.2 at a third pressure level and at a second pressure level. The first and third pressure levels may be equal or may differ, just as the second and fourth pressure levels may be equal or may differ.

The injection assembly 301 further comprises:
a first differential pressure valve 200.1 able to receive cleaning fluid via the first injection channel 452.1, and to transmit it into a first distribution channel 453.1 or into a second distribution channel 453.2 according to the pressure of the cleaning fluid;
a second differential pressure valve 200.2 able to receive cleaning fluid via the second injection channel 452.2, and to transmit it into a third distribution channel 452.3 or into a fourth distribution channel 452.4.

The first distribution channel 453.1 is able to convey the cleaning fluid toward one or more first spray element(s) 111, 112, 113, 114 or 116, and the second distribution channel 453.2 is able to convey the cleaning fluid toward one or more second spray element(s) 111, 112, 113, 114 or 116.

The third distribution channel 443.3 is able to convey the cleaning fluid toward one or more third spray element(s) 111, 112, 113, 114 or 116, and the fourth distribution channel 443.4 is able to convey the cleaning fluid toward one or more fourth spray element(s) 111, 112, 113, 114 or 116.

The pumps 451.1 and 451.2 may be controlled by the control unit 303 or by a plurality of control units 303.

Thus, in the sixth embodiment, the wiping system 100 comprises four distribution channels leading to distinct sets of spray elements and may advantageously use two differential pressure valves 200 enabling the use of two pumps in place of four and making it possible to shorten the length of the distribution channels 453.1, 453.2, 453.3 and 453.4.

FIG. 4g presents a seventh fluid injection assembly 301 of a wiping system according to a seventh embodiment of the invention.

In the seventh embodiment, the injection assembly 301 comprises a dual-pressure and two-directional pump 461 able to inject cleaning fluid from the reservoir 305 at a first pressure level and at a second pressure level into a first injection channel 462.1 or into a second injection channel 462.2 according to the direction of rotation of the motor of the pump 461.

The injection assembly 301 further comprises:
a first differential pressure valve 200.1 able to receive cleaning fluid via the first injection channel 462.1, and to transmit it into a first distribution channel 463.1 or into a second distribution channel 463.2 according to the pressure of the cleaning fluid;
-a second differential pressure valve 200.2 able to receive cleaning fluid via the second injection channel 462.2, and to transmit it into a third distribution channel 462.3 or into a fourth distribution channel 462.4.

The first distribution channel 463.1 is able to convey the cleaning fluid toward one or more first spray element(s) 111, 112, 113, 114 or 116, and the second distribution channel 463.2 is able to convey the cleaning fluid toward one or more second spray element(s) 111, 112, 113, 114 or 116.

The third distribution channel 463.3 is able to convey the cleaning fluid toward one or more third spray element(s) 111, 112, 113, 114 or 116, and the fourth distribution channel 463.4 is able to convey the cleaning fluid toward one or more fourth spray element(s) 111, 112, 113, 114 or 116.

The pump 461 may be controlled by the control unit 303.

Thus, in the sixth embodiment, the wiping system 100 comprises four distribution channels leading to distinct sets of spray elements and may advantageously use two differential pressure valves 200 enabling the use of just one pump in place of four and making it possible to shorten the length of the distribution channels 453.1, 453.2, 453.3 and 453.4. However, in comparison with this seventh embodiment, the other embodiments allow cleaning fluid to be injected into at least two distribution channels simultaneously.

The invention is not limited to the examples which have just been described, and numerous amendments can be made to these examples without departing from the scope of the invention

What is claimed is:

1. A wiping system for a motor vehicle, comprising:
a wiper blade configured to wipe a visibility zone of a windshield of the vehicle;
at least one first spray element able to receive cleaning fluid and to spray the cleaning fluid;
at least one second spray element able to receive cleaning fluid and to spray the cleaning fluid;
an injection assembly which is able to selectively inject cleaning fluid toward the at least one first spray element or toward the at least one second spray element, the injection assembly comprising-includes at least a first dual-pressure pump able to inject cleaning fluid at at least a first pressure level and a second pressure level, the injection assembly also includes a first differential pressure valve, the first valve being able to receive cleaning fluid and to transmit the cleaning fluid toward the at least one first spray element when the cleaning fluid is received at the first pressure level and to transmit the cleaning fluid toward the at least second spray element when the cleaning fluid is received at the second pressure level.

2. The wiping system as claimed in claim 1, further comprising at least a third spray element element, injection assembly includes a second pump able to inject cleaning fluid toward the at least one third spray element.

3. The wiping system as claimed in claim 1, further comprising at least a third spray element, the first dual-pressure pump pump being configured to inject the cleaning fluid toward the first differential pressure valve and/or toward the at least one third spray element.

4. The wiping system as claimed in claim 2, further comprising at least a fourth spray element, the injection assembly includes an additional pump able to inject cleaning fluid toward the at least one fourth spray element.

5. The wiping system as claimed in claim 2, further comprising at least a fourth spray element, the second pump being configured to inject the cleaning fluid toward the at least one third spray element and/or toward the at least one fourth spray element.

6. The wiping system as claimed in claim 5, wherein the second pump is a two-directional pump able to selectively inject cleaning fluid toward the at least one third spray element and toward the at least one fourth spray element.

7. The wiping system as claimed in claim 5, wherein the second pump is a dual-pressure pump able to inject cleaning fluid at at least a third pressure level and a fourth pressure level, and wherein the injection assembly comprises-includes a second differential pressure valve, the second valve being able to receive cleaning fluid and to transmit the cleaning fluid toward the third spray element when the cleaning fluid is received at the third pressure level and to transmit the cleaning fluid toward the fourth spray element nezzle when the cleaning fluid is received at the fourth pressure level.

8. The wiping system as claimed in claim 3, further comprising at least a fourth spray element and wherein the first pump is a dual-pressure and two-directional pump able to selectively inject cleaning fluid toward the first differential pressure valve or toward a second differential pressure valve, the second valve being able to transmit the cleaning fluid toward the third spray element when the cleaning fluid is received at the first pressure level and to transmit the cleaning fluid toward the fourth spray element when the cleaning fluid is received at the second pressure level.

9. The wiping system as claimed in claim 1. wherein at least one of the first and second spray elements is able to spray cleaning fluid onto a glazed surface able to be wiped by the wiping system, and is arranged at a fixed position on a motor-vehicle hood, in the arm or in the wiper blade.

10. The wiping system as claimed in claim 9, wherein the at least one first spray element is arranged in the wiper blade so as to spray cleaning fluid in a direction that is inclined with respect to a longitudinal direction of the wiper blade.

11. The wiping system as claimed in claim 10, wherein the at least one second spray element is arranged in the wiper blade so as to spray cleaning fluid in a second direction that is inclined with respect to the longitudinal direction of the wiper blade, the second direction being different than the first direction.

12. The wiping system as claimed in claim 9, wherein at least one of the spray elements elements is arranged in an end zone of the wiper blade and is able to spray cleaning fluid toward an optical surface of a motor-vehicle sensor.

13. The wiping system as claimed in claim 12, wherein at least another of the spray elements is able to spray cleaning fluid toward another optical surface of another motor-vehicle sensor
